(19) United States
(12) Patent Application Publication
(10) Pub. No.: US 2021/0131453 A1
(43) Pub. Date: May 6, 2021

(54) HYDRAULIC AMPLIFIER

(71) Applicant: Loon LLC, Mountain View, CA (US)

(72) Inventors: Mathew Tabor, San Francisco, CA (US); Keegan Gartner, Los Gatos, CA (US)

(21) Appl. No.: 16/674,545

(22) Filed: Nov. 5, 2019

(51) Int. Cl. F15B 3/00

(52) U.S. Cl. CPC F15B 3/00

(57) ABSTRACT

Aspects of the disclosure relate to a hydraulic amplifier. The hydraulic amplifier may include a piston body having a movable piston that divides an interior of the piston body into a first chamber and a second chamber. The piston may include a shaft, and the piston may include a fluid port for filling the first chamber with a first compressible fluid. The hydraulic amplifier may also include a hydraulic body attached to the piston body. The hydraulic body may include a third chamber having a second compressible fluid therein. The shaft may be arranged at least partially in the third chamber. The shaft is configured to compress the second fluid by amplifying a pressure of the first fluid according to a ratio of a cross-sectional area of the first or second chamber to a cross-sectional area of the third chamber.

### BACKGROUND

High pressure hydraulic circuits may be used, for instance, with pneumatic devices or tools for various purposes. However, not only are these circuits fairly complicated including reservoirs, sensors, pumps, valves, fillers, drains, etc., which can make then liable to failures, they can also be expensive. In other instances, high pressure fluid sources for providing stored energy may not be readily available.

### BRIEF SUMMARY

Aspects of the present disclosure provide a system comprising a hydraulic amplifier. The hydraulic amplifier includes a piston body including a movable piston having a base that divides an interior of the piston body into a first chamber and a second chamber. The piston also includes a shaft, the piston body including at least one fluid port for filling the first chamber with a first fluid. The first fluid is a compressible fluid. The hydraulic amplifier also includes a hydraulic body attached to the piston body, the hydraulic body including a third chamber having a second fluid therein. The second fluid is a second compressible fluid. The shaft is arranged at least partially in the third chamber, the hydraulic body further including a plurality of fluid ports including a first fluid port for attachment with a pressure sensor and a second fluid port for attachment with a tool. The shaft is configured to compress the second fluid by amplifying a pressure of the first fluid according to a ratio of a cross-sectional area of the first or second chamber to a cross-sectional area of the third chamber.

In one example, the system also includes the tool, and the compressed second fluid is configured to activate the tool by way of the second fluid port. In another example, the piston body further includes another fluid port configured to allow the compressed fluid to escape the first chamber in order to reset the movable piston. In another example, the at least one fluid port is arranged to enable gravity to assist the compressed first fluid in filling the first chamber, and the another fluid port is arranged to enable gravity to assist fluid in escaping the first chamber. In another example, the first fluid is compressed air. In addition, the second fluid is hydraulic oil. In another example, the hydraulic body further includes a third fluid port configured as a safety device for situations in which pressure of the second fluid surpasses a threshold. In another example, the hydraulic body further includes a third fluid port configured for adding the second fluid to the third chamber. In another example, the hydraulic body further includes a third fluid port configured for draining the second fluid from the third chamber for maintenance. In another example, the piston body is cylindrical, and the hydraulic body is cylindrical. In this example, the ratio corresponds to a square of a radius of the first chamber or the second chamber to the square of a radius of the third chamber. In another example, the amplification is at least 40 times.

Another aspect of the disclosure provides a hydraulic amplifier. The hydraulic amplifier consists essentially of a piston body and a hydraulic body. The piston body includes a movable piston having a base that divides an interior of the piston body into a first chamber and a second chamber. The piston also includes a shaft, the piston body including at least one fluid port for filling the first chamber with a first fluid, the first fluid being a compressible fluid. The hydraulic body is attached to the piston body. The hydraulic body including a third chamber having a second fluid therein, the second fluid being a second compressible fluid, the shaft being arranged at least partially in the third chamber. The hydraulic body also includes a plurality of fluid ports including a first fluid port for attachment with a pressure sensor and a second fluid port for attachment with a tool. The shaft is configured to compress the second fluid by amplifying a pressure of the first fluid according to a ratio of a cross-sectional area of the first or second chamber to a cross-sectional area of the third chamber.

In one example, the first fluid is compressed air. In addition, the second fluid is hydraulic oil. In another example, the piston body is cylindrical and the hydraulic body is cylindrical. In this example, the ratio corresponds to a square of a radius of the first chamber or the second chamber to the square of a radius of the third chamber. In another example, the amplification is at least 40 times.

A further aspect of the disclosure provides a method for using a hydraulic amplifier including a hydraulic body and a piston body including a first chamber and a second chamber. The method includes filling the first chamber of the piston body with a first fluid via a first fluid port of the piston body; causing a piston to move within the piston body from a rest position to an active position and thereby increasing a size of the first chamber and decreasing a size of a second chamber; compressing a second fluid within a third chamber of a hydraulic body; and using the compressed second fluid to activate a tool connected to a fluid port of the hydraulic body.

In one example, the method also includes, after activating the tool, causing the piston to return to the rest position.

### BRIEF DESCRIPTION OF THE DRAWINGS

FIG. 1 is a perspective view of an example hydraulic amplifier in accordance with aspects of the disclosure.

FIG. 2 is a cross-sectional view of the hydraulic amplifier of FIG. 1 in accordance with the aspects of the disclosure.

FIG. 3 is another cross-sectional view of the hydraulic amplifier of FIG. 1 in accordance with the aspects of the disclosure.

FIG. 4 is another example perspective view of the hydraulic amplifier of FIG. 1 with various devices connected to a plurality of fluid ports in accordance with aspects of the disclosure.

FIG. 5 is an example flow diagram in accordance with aspects of the disclosure.

FIG. 6 is an example system in which the hydraulic amplifier of FIG. 1 may be used in accordance with aspects of the present disclosure.

FIG. 7 is yet another example perspective view of the hydraulic amplifier of FIG. 1 with various devices connected to a plurality of fluid ports in accordance with aspects of the disclosure.

### DETAILED DESCRIPTION

### Overview

The present disclosure generally relates to situations in which high pressure hydraulic circuits are required. As noted above, such circuits may typically be used, for instance, for pneumatic devices or tools for various purposes. However, not only are these circuits fairly complicated including reservoirs, sensors, pumps, valves, fillers, drains, etc., which can make then liable to failures, they can also be expensive. In other instances, high pressure fluid sources for providing stored energy may not be readily available. To address these shortcomings, a simplified, unibody, single-shot hydraulic amplifier may be used to replace an entire hydraulic circuit.

The hydraulic amplifier may include a cylindrical piston body and a cylindrical hydraulic body. Within the piston body is a movable piston. The piston divides the piston body into first and second chambers. The piston body may include a first fluid port in fluid communication with the first chamber. The first fluid port may be attached to a fluid source, such as a compressor that provides compressed air.

Filling the first chamber with fluid, such as the compressed air, via the first fluid port may cause the piston to be moved towards the hydraulic body connected to the piston body. This movement may increase the size of the first chamber and decrease the size of the second chamber. The air may also be able to escape from the first chamber via the first fluid port, or alternatively through a second port which may be a drain or vent port that can be opened in order to allow air to exit the first chamber and allow the movable piston to rest.

The movable piston also includes a shaft arranged at least partially in an opening corresponding to a third chamber in the hydraulic body. The third chamber may include a plurality of fluid ports for various purposes.

The configuration of the hydraulic amplifier enables a lower pressure fluid source to create a higher pressure compressed fluid. This highly compressed fluid may then be used to activate a tool connected to a fluid port of the hydraulic body.

The features described herein may provide a simplified hydraulic amplifier which can be used to replace many types of more complicated hydraulic circuits. The hydraulic amplifier may thus be useful in various applications including manufacturing, automation, etc. which require high pressure fluid sources for actuating tools for forming, holding, crimping, cutting, etc. In addition, the hydraulic amplifier may be especially useful in situations in which other high-pressure fluid sources are not readily available.

### Example Hydraulic Amplifier

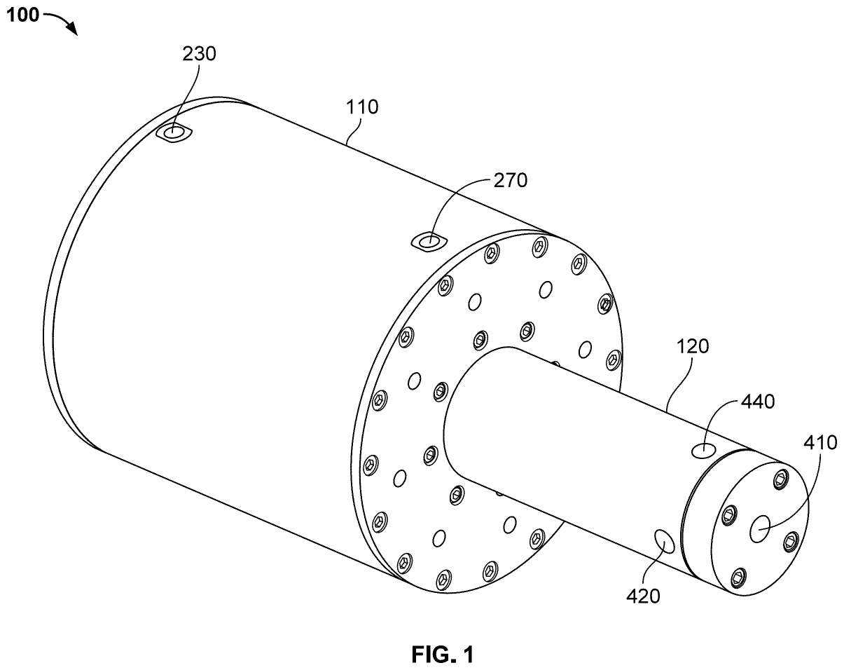

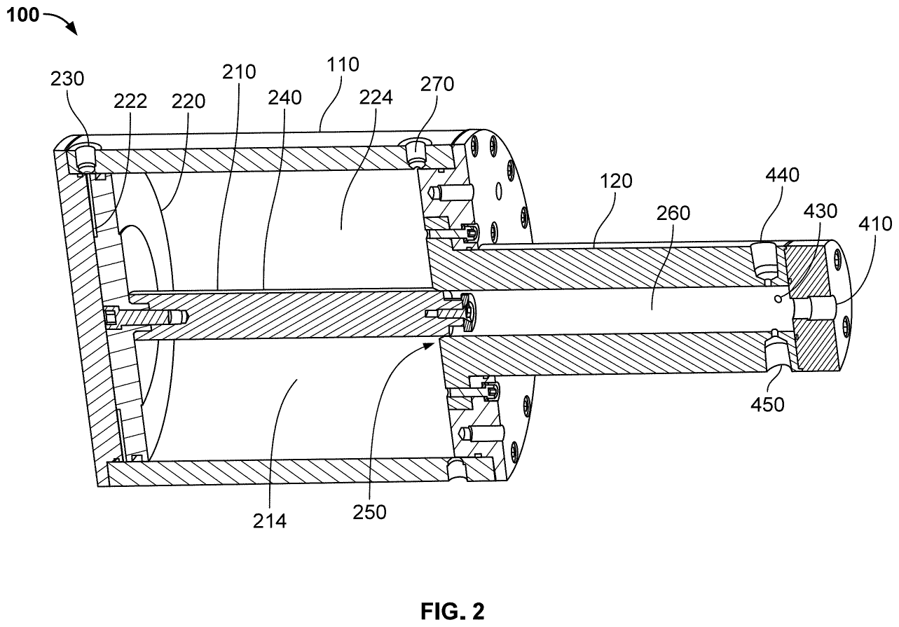

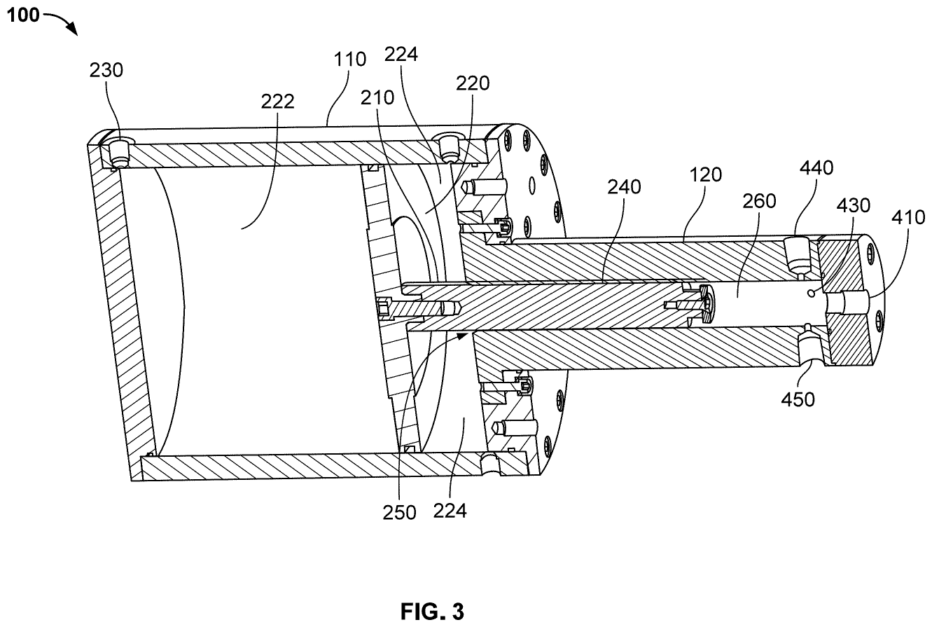

FIG. 1 is a perspective view of an example hydraulic amplifier 100. The hydraulic amplifier may include a piston body 110 and a hydraulic body 120. Each of the piston body and hydraulic body are cylindrical or are shaped as cylinders. FIGS. 2 and 3 are cross-sectional views of the hydraulic amplifier 100. Within the piston body is a piston 210. The piston 210 includes a base 220 that divides the piston body into first and second chambers 222 (better visible in FIG. 3), 224, respectively. In this example, an interior space of the piston body 210, which includes the first and second chambers 222, 224, has a cylindrical shape, and the base 220 also has a cylindrical shape. This may allow the base 220 to freely move within the interior space of the piston body 110, while at the same time maintaining an air-tight seal between the first and second chambers 222 and 224. As such, when the first chamber 222 is pressurized with the first fluid, the first fluid may stay within the first chamber rather than escaping to the second chamber 224.

The piston 210 also includes a shaft 240 arranged at least partially in an opening 250 there by creating a third chamber 260 in the hydraulic body 120. The third chamber 260 may include a second fluid. This second fluid may be a non-compressible fluid, to more easily achieve higher pressures, such as hydraulic oil.

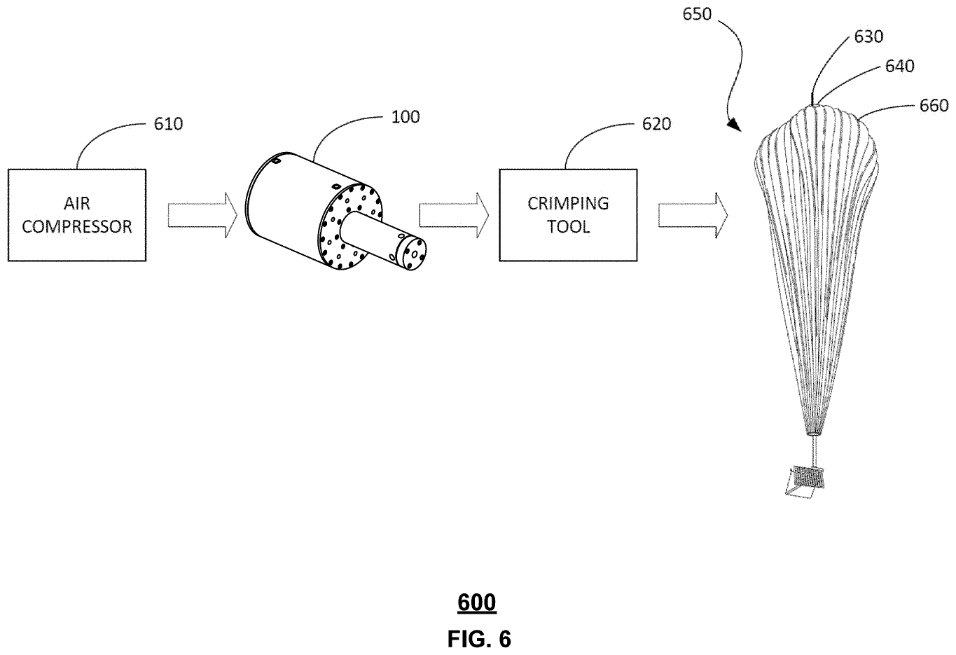

The piston body includes a first fluid port 230 in fluid communication with the first chamber 222. The first fluid port 230 may allow a first fluid to enter into the first chamber 222. This first fluid may be a compressible fluid, such as air. In this regard, the first fluid port 230 may be attached to a fluid source, such as an air compressor 610 that provides compressed air shown in FIG. 6. In addition, the piston body also includes a second fluid port 270 in fluid communication with the second chamber 224. The second fluid port may be used to enable air to freely enter and exit the second chamber 224, and thereby maintain atmospheric pressure within the second chamber no matter what the state of the first chamber 210, third chamber 260, or piston 210.

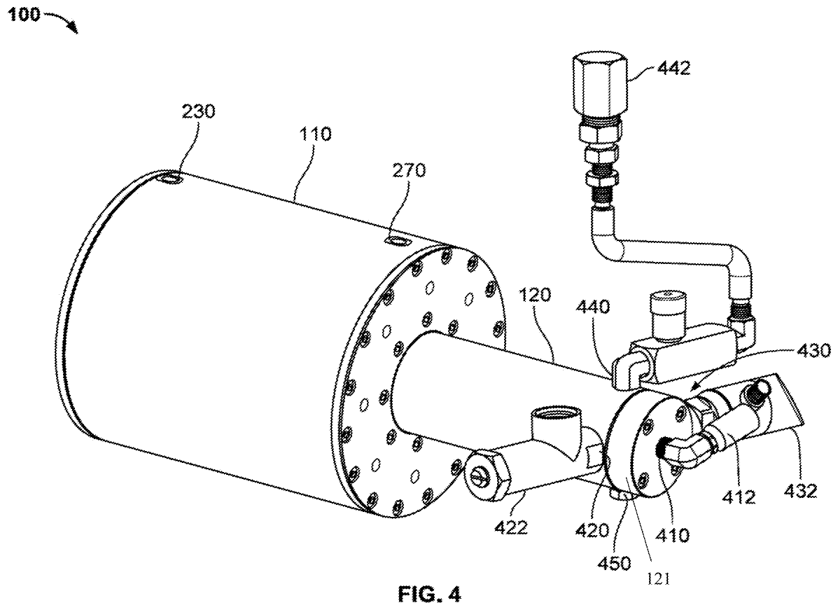

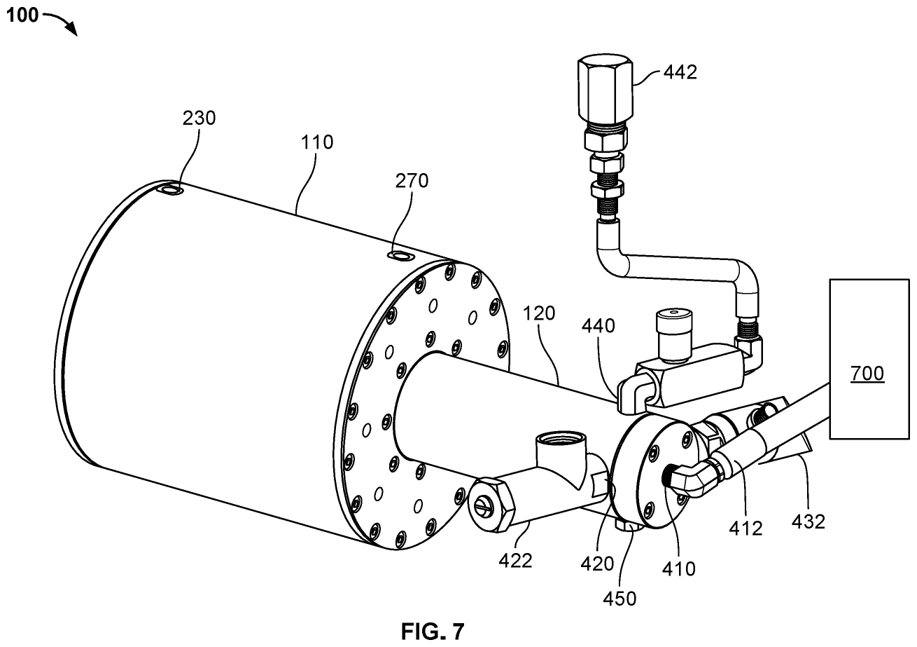

The hydraulic body 120 may also include a plurality of fluid ports in fluid communication with the third chamber 260 for various purposes. FIG. 4 is another example perspective view of the hydraulic amplifier 110 with various devices connected to a plurality of fluid ports. For instance, the hydraulic amplifier 100 include five ports 410, 420, 430, 440, 450. For example, a third fluid port 410 may be attached to a tool 700 or other device that can be actuated by pressurized fluid, as shown in FIG. 7. FIGS. 4 and 7 depict a connection device 412 which can be connected to a tool 700. In addition, a fourth fluid 420 port may be attached to a pressure relief device 422 which acts as a safety device if pressure of the second fluid in the third chamber becomes too high (e.g. surpasses a predetermined threshold), a fifth fluid 430 port may be attached to a pressure sensor 432 to allow monitoring, for instance by an observer or a computing device, of the pressure in the chamber both for determining the status of the hydraulic amplifier as well as the tool.

A sixth fluid port 440 may be used to fill the third chamber with fluid, and thereafter, the sixth fluid port may be sealed, for instance, using a plug or other device or materials. FIG. 4 also depicts a fill port device 442 connected to the sixth fluid port for these purposes. Alternatively, one of the third, fourth or fifth ports may also be used to fill the third chamber with the second fluid. A seventh fluid port 450 may be used to drain the second fluid. Alternatively to the seventh fluid port, the plug, tool, relief port, and/or sensor may be removable in order to allow for periodic filling and/or replacement of the hydraulic oil.

### Example Methods

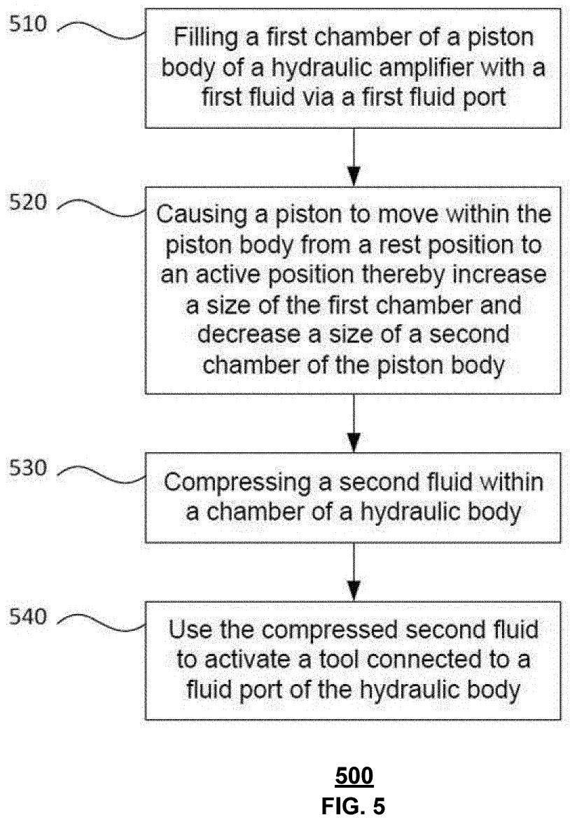

For example, FIG. 5 is an example flow diagram 500 for using a hydraulic amplifier, such as the hydraulic amplifier 100 described above. In this example, at block 510, a first chamber of a piston body of a hydraulic amplifier is filled with a first fluid via a first fluid port. For example, the first chamber 222 may be filled with a first fluid, such as compressed air, via the first fluid port 230. The compressed air may be supplied by an air compressor 610 depicted in FIG. 6.

At block 520 of FIG. 5, a piston is caused to move within the piston body from a rest position to an active position thereby increasing a size of the first chamber and decreasing a size of a second chamber of the piston body. For example, the compressed air may enter into the first chamber 222, causing the base 220 of the piston 210 to move from a rest position depicted in FIG. 2 to an active position depicted in FIG. 3. This movement may increase the size or volume of the first chamber 222 and decrease the size or volume of the second chamber 224.

At block 530 of FIG. 5, a second fluid within a chamber of a hydraulic body is compressed. Moving to the active position may cause the shaft 240 of the piston to be moved further into the opening 250 of the hydraulic body 120, and thereby decreasing the size or volume of the third chamber 260. The decrease in size of the third chamber may thus compress the second fluid in the third chamber by a factor proportional to a ratio of the cross-sectional area of the third chamber to the cross-sectional area of the first or second chamber 222, 224.

The configuration of the hydraulic amplifier may enable a lower pressure fluid source to create a higher pressure compressed fluid. For instance, pumping air into the first chamber 222 may cause the piston 210 to force the shaft 240 into the third chamber 260, and thereby compress the second fluid in the third chamber. The difference in diameter of the first or second chamber 222, 224 (as these chambers have the same diameters) relative to the diameter of the third chamber may actually cause an amplification in the pressure of the second fluid in the third chamber. This amplification may be defined as a ratio of the cross-sectional area of the third chamber to the cross-sectional area of the first or second chamber 222, 224.

The cross-sectional area of each of the first, second, and third chambers 222, 224, 260 may be defined by π*r2, where r represents a respective radius of each chamber. Because pressure is determined by force over area, the ratio may be simplified to the square of the radius of the first or second chamber 222, 224 over the square of the radius of the third chamber 260. For example, if the radius R3 of the third chamber 260 is 6.5 times smaller than the radius R1, R2 respectively, of the first or second chamber 222, 224, the amplification of the pressure of the first and second fluids or rather, between the second and third chambers may be 42.25 times (or 6.5 squared). In that regard, if compressed air at 100 PSI is introduced into the first chamber, this may result in the hydraulic oil being compressed to approximately 4225 PSI.

At block 540 of FIG. 5, the compressed second fluid is used to activate a tool connected to a fluid port of the hydraulic body. For instance, the highly compressed hydraulic oil within the third chamber 260 may then be used to activate the tool connected to the third fluid port 410. The actual pressure of the second fluid in the third chamber 260 may be measured using the pressure sensor 430, and thus, the pressure sensor may be used to determine when the tool can be activated, such as when the pressure meets a predetermined desired amount for activating the tool.

FIG. 6 depicts an example system 600 in which the hydraulic amplifier 100 may be used. As one example, the highly compressed hydraulic oil may be used to activate a crimping tool for crimping and creating an air-tight seal at a fill port of a balloon. As shown in FIG. 6, an air compressor 610 may provide compressed air to the hydraulic amplifier 100. Once the desired pressure is reached, a crimping tool 620 may be activated in order to crush and cut a copper fill port 630 of a top plate 640 of a balloon 650. This may thus create a fluid tight seal for an envelope 660 of the balloon.

Of course, as noted above, the hydraulic amplifier may be used to replace hydraulic circuits for any number of different types of applications. However, to ensure proper function of the hydraulic amplifier, the hydraulic amplifier should be mounted such that the path of the piston is generally perpendicular to the direction of gravity and such that gravity can be used to assist or enable the filling and draining of the first chamber.

After the tool is activated, the first fluid may also be able to escape from the first chamber via the first fluid port 230. In this regard, the first fluid port may enable fluid (e.g. air) exit from the first chamber 222 and allow the movable piston to reset or return to the rest position depicted in FIG. 2 from the active position depicted in FIG. 3.

The features described herein may provide a simplified hydraulic amplifier which can be used to replace many types of more complicated hydraulic circuits. The hydraulic amplifier may thus be useful in various applications including manufacturing, automation, etc. which require high pressure fluid sources for actuating tools for forming, holding, crimping, cutting, etc. In addition, the hydraulic amplifier may be especially useful in situations in which other high-pressure fluid sources are not readily available.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising a hydraulic amplifier including:
a piston body including a movable piston having a base that divides an interior of the piston body into a first chamber and a second chamber, the piston further including a shaft, the piston body including at least one fluid port for filling the first chamber with a first fluid, the first fluid being a compressible fluid; and
a hydraulic body attached to the piston body, the hydraulic body including a third chamber having a second fluid therein, the second fluid being a second compressible fluid, the shaft being arranged at least partially in the third chamber, the hydraulic body further including a plurality of fluid ports including a first fluid port for attachment with a pressure sensor and a second fluid port for attachment with a tool, the second fluid port defined on and located at an end cap portion of the hydraulic body, and the shaft is configured to compress the second fluid by amplifying a pressure of the first fluid according to a ratio of a cross-sectional area of the first or second chamber to a cross-sectional area of the third chamber.

2. The system of claim 1, further comprising the tool, and wherein the compressed second fluid is configured to activate the tool by way of the second fluid port.

3. The system of claim 1, wherein the piston body further includes another fluid port configured to allow the compressed fluid to escape the first chamber in order to reset the movable piston.

4. The system of claim 3, wherein the at least one fluid port is arranged to enable gravity to assist the compressed first fluid in filling the first chamber, and the another fluid port is arranged to enable gravity to assist fluid in escaping the first chamber.

5. The system of claim 1, wherein the first fluid is compressed air.

6. The system of claim 5, wherein the second fluid is hydraulic oil.

7. The system of claim 1, wherein the hydraulic body further includes a third fluid port configured as a safety device is for situations in which pressure of the second fluid surpasses a threshold.

8. The system of claim 7, wherein the hydraulic body further includes a fourth fluid port configured for adding the second fluid to the third chamber.

9. The system of claim 8, wherein the hydraulic body further includes a fifth fluid port configured for draining the second fluid from the third chamber for maintenance.

10. The system of claim 1, wherein the piston body is cylindrical, and the hydraulic body is cylindrical.

11. The system of claim 10, wherein the ratio corresponds to a square of a radius of the first chamber or the second chamber to the square of a radius of the third chamber.

12. The system of claim 1, wherein the amplification is at least 40 times.

13. A hydraulic amplifier consisting essentially of:
a piston body including a movable piston having a base that divides an interior of the piston body into a first chamber and a second chamber, the piston further including a shaft, the piston body including at least one fluid port for filling the first chamber with a first fluid, the first fluid being a compressible fluid; and
a hydraulic body attached to the piston body, the hydraulic body including a third chamber having a second fluid therein, the second fluid being a second compressible fluid, the shaft being arranged at least partially in the third chamber, the hydraulic body further including a plurality of fluid ports including a first fluid port for attachment with a pressure sensor and a second fluid port for attachment with a tool, the second fluid port defined on and located at an end cap portion of the hydraulic body, and the shaft is configured to compress the second fluid by amplifying a pressure of the first fluid according to a ratio of a cross-sectional area of the first or second chamber to a cross-sectional area of the third chamber.

14. The hydraulic amplifier of claim 13, wherein the first fluid is compressed air.

15. The hydraulic amplifier of claim 14, wherein the second fluid is hydraulic oil.

16. The hydraulic amplifier of claim 13, wherein the piston body is cylindrical and the hydraulic body is cylindrical.

17. The hydraulic amplifier of claim 16, wherein the ratio corresponds to a square of a radius of the first chamber or the second chamber to the square of a radius of the third chamber.

18. The hydraulic amplifier of claim 13, wherein the amplification is at least 40 times.

19. A method for using a hydraulic amplifier including a hydraulic body and a piston body including a first chamber and a second chamber, the method comprising:
filling the first chamber of the piston body with a first fluid via a first fluid port of the piston body;
causing a piston to move within the piston body from a rest position to an active position and thereby increasing a size of the first chamber and decreasing a size of a second chamber;
compressing a second fluid within a third chamber of the hydraulic body, the hydraulic body including a plurality of fluid ports, one of the plurality of fluid ports defined on and located at an end cap portion of the hydraulic body; and
using the compressed second fluid to activate a tool connected to a fluid port of the hydraulic body.

20. The method of claim 19, further comprising, after activating the tool, causing the piston to return to the rest position.
